(19) United States
(12) Patent Application Publication
(10) Pub. No.: US 2026/0172214 A1
(43) Pub. Date: Jun. 18, 2026

(54) HANDLING OF RECEIVE TIMING DIFFERENCE OF INTRA-BAND CARRIERS

(71) Applicant: Nokia Technologies Oy, Espoo (FI)

(72) Inventors: Lei DU, Beijing (CN); Lars DALSGAARD, Oulu (FI); Yue Ji CHEN, Hangzhou (CN)

(21) Appl. No.: 19/111,194

(22) PCT Filed: Oct. 7, 2022
(86) PCT No.: PCT/CN2022/123732

§ 371 Date: Mar. 12, 2025

(51) Int. Cl. H04L 5/00; H04L 27/26

(52) U.S. Cl. CPC H04L 5/0098; H04L 27/2678

(57) ABSTRACT

Embodiments of the present disclosure relate to handling of RTD of intra-band carriers. A first device receives, from a second device, an indication indicating that information of a RTD relevant to a first cell and a serving cell is to be reported, the first cell being non-co-located with the serving cell in a frequency band. The first device transmits the information of the RTD to the second device. In this way, information of RTD of a non-co-located cell may be indicated to a network for optimization of network scheduling and system performance.

### FIELD

Various example embodiments relate to the field of telecommunication and in particular, to a method, device, apparatus and computer readable storage medium of communication in handling of receive timing difference (RTD) of intra-band carriers.

### BACKGROUND

As known, for frequency range 1 (FR1) intra-band carrier aggregation (CA), it is assumed that different carriers or cells are co-located, and a maximum receive time difference (MRTD) of 3 μs is expected considering similar propagation delays. When a non-co-located scenario is introduced, if a MRTD for intra-band CA follows a value of 33 μs defined for inter-band CA where a non-co-located carrier is assumed, such longer MRTD may result in potential performance degradation. This will bring challenges in network scheduling and system performance.

### SUMMARY

In general, example embodiments of the present disclosure provide a solution of handling a RTD of intra-band carriers.

In a first aspect, there is provided a first device. The first device comprises at least one processor; and at least one memory storing instructions that, when executed by the at least one processor, cause the first device at least to: receive, from a second device, an indication indicating that information of a receive timing difference relevant to a first cell and a serving cell is to be reported, the first cell being non-co-located with the serving cell in a frequency band; and transmit, to the second device, the information of the receive timing difference.

In a second aspect, there is provided a second device. The second device comprises at least one processor; and at least one memory storing instructions that, when executed by the at least one processor, cause the second device at least to: transmit, to a first device, an indication indicating that information of a receive timing difference relevant to a first cell and a serving cell is to be reported, the first cell being non-co-located with the serving cell in a frequency band; and receive, from the first device, the information of the receive timing difference.

In a third aspect, there is provided a method for communication. The method comprises: receiving, at a first device and from a second device, an indication indicating that information of a receive timing difference relevant to a first cell and a serving cell is to be reported, the first cell being non-co-located with the serving cell in a frequency band; and transmitting, to the second device, the information of the receive timing difference.

In a fourth aspect, there is provided a method for communication. The method comprises: transmitting, at a second device and to a first device, an indication indicating that information of a receive timing difference relevant to a first cell and a serving cell is to be reported, the first cell being non-co-located with the serving cell in a frequency band; and receiving, from the first device, the information of the receive timing difference.

In a fifth aspect, there is provided an apparatus for communication. The apparatus comprises: means for receiving, at a first device and from a second device, an indication indicating that information of a receive timing difference relevant to a first cell and a serving cell is to be reported, the first cell being non-co-located with the serving cell in a frequency band; and means for transmitting, to the second device, the information of the receive timing difference.

In a sixth aspect, there is provided an apparatus for communication. The apparatus comprises: means for transmitting, at a second device and to a first device, an indication indicating that information of a receive timing difference relevant to a first cell and a serving cell is to be reported, the first cell being non-co-located with the serving cell in a frequency band; and means for receiving, from the first device, the information of the receive timing difference.

In a seventh aspect, there is provided a non-transitory computer readable medium comprising program instructions that, when executed by an apparatus, cause the apparatus to perform at least the method according to the third or fourth aspect.

In an eighth aspect, there is provided a computer program comprising instructions, which, when executed by an apparatus, cause the apparatus to perform at least the method according to the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which embodiments of the present disclosure may be implemented;

FIG. 2 illustrates a diagram illustrating an example RTD between intra-band carriers in a non-co-located scenario in which embodiments of the present disclosure may be implemented;

FIG. 3 illustrates a diagram illustrating a process of communication for RTD handling according to some embodiments of the present disclosure;

FIG. 4 illustrates a diagram illustrating an example process of adding a cell as a secondary cell (SCell) according to some embodiments of the present disclosure;

FIG. 5A illustrates a diagram illustrating an example process of activating a cell configured as a SCell according to some embodiments of the present disclosure;

FIG. 5B illustrates a diagram illustrating an example process of deactivating a cell configured as a SCell according to some embodiments of the present disclosure;

FIG. 6 illustrates a flowchart of an example method implemented at a first device according to some embodiments of the present disclosure;

FIG. 7 illustrates a flowchart of an example method implemented at a second device according to some embodiments of the present disclosure;

FIG. 8 illustrates a simplified block diagram of a device that is suitable for implementing embodiments of the present disclosure; and

FIG. 9 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) next generation NodeB (also referred to as a gNB), a Remote Radio Unit (RRU), a radio header (RH), a remote radio head (RRH), a relay, a low power node such as a femto, a pico, and so forth, depending on the applied terminology and technology. An RAN split architecture comprises a gNB-CU (Centralized unit, hosting RRC, SDAP and PDCP) controlling a plurality of gNB-DUs (Distributed unit, hosting RLC, MAC and PHY).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

Until the third generation partnership project (3GPP) Release 17, only a co-located scenario has been assumed upon definition of RRM requirements for FR1 intra-band non-contiguous NR-CA and for intra-band EN-DC. For intra-band EN-DC, MRTD requirements are defined based on UE capability of asynchronous EN-DC. As MRTD requirements for FR1 intra-band non-contiguous NR-CA, the UE shall be capable of handling at least a relative receive timing difference of 3 us between slot timings of different carriers to be aggregated at the UE, as shown in Table 1 below. Table 1 shows an example MRTD requirement for intra-band non-contiguous NR CA according to conventional solution.

TABLE 1

| Frequency Range | MRTD (μs) |
|---|---|
| FR1 | 3 |
| FR2 | 0.26 |

Note 1:
In the case of different SCS on different CCs, if the receive time difference exceeds the cyclic prefix length of that SCS, demodulation performance degradation is expected for the first symbol of the slot.

However, from operators' perspective, UE requirements for non-co-located deployment are essential to enhance NR-CA/EN-DC available areas. Recently, it is approved to define the UE requirements supporting intra-band NR-CA/EN-DC deployment in a non-co-located scenario.

In view of this, embodiments of the present disclosure provide a solution of handling RTD of intra-band carriers in a non-co-located scenario. In the solution, a first device receives, from a second device, an indication indicating that information of the RTD relevant to a first cell and a serving cell is to be reported, the first cell being non-co-located with the serving cell in a frequency band. The first device evaluates the RTD relevant to a receive timing of the serving cell and arrival timing of the first cell on the same frequency band. Then the first device transmits information of the RTD to the second device.

In this way, a terminal device may evaluate RTD for a non-co-located carrier and indicate the RTD to a network. With such indication, the network may control scheduling to minimize performance degradation. Further, a receive timing on a frequency band may be adjusted to minimize performance degradation.

Principles and implementations of the present disclosure will be described in detail below with reference to the figures.

FIG. 1 illustrates a schematic diagram of an example communication environment 100 in which some embodiments of the present disclosure can be implemented. As shown in FIG. 1, the communication environment 100 may include a first device 110, a second device 120 and a third device 130. The second device 120 may provide a group of cells (e.g., cells 121 and 122 are shown) to serve one or more devices. The third device 130 may also provide a group of cells (for convenience, only one cell 131 is shown) to serve one or more devices.

In some embodiments, the first device 110 may be located in the cell 121 and served by the second device 120. The first device 110 may be configured with CA. The first device 110 may be served by the second device 120 and may be connected with both the cells 121 and 122 of the second device 120. As an example, the cell 121 may serve as a primary cell (PCell), and the cell 122 may serve as a SCell. In this case, the cell 121 and the cell 122 are co-located.

In some embodiments, the second device 120 and the third device 130 operate in the same frequency band (e.g., FR1). The first device 110 is not served by the third device 130, and the cell 131 is non-co-located with the cells 121 and 122. In some embodiments, the second device 120 and the third device 130 may be the same device.

It is to be understood that the number of devices and cells in FIG. 1 is given for the purpose of illustration without suggesting any limitations to the present disclosure. The communication environment 100 may include any suitable number of first devices and/or second devices and/or third devices and/or cells adapted for implementing implementations of the present disclosure. In some embodiments, the first device 110 may be a terminal device, and the second and third devices 120 and 130 may be network devices.

Merely for illustration purposes and without suggesting any limitations as to the scope of the present disclosure, some embodiments will be described in the context where the first device 110 is a terminal device and the second and third devices 120 and 130 are network devices. It is to be understood that, in other embodiments, the first device 110 may be a network device and any of the second and third devices 120 and 130 may be a terminal device. In other words, the principles and spirit of the present disclosure may be applied to both uplink and downlink transmissions.

As shown in FIG. 1, the first device 110 and any of the second device 120 and the third device 130 may communicate with each other via a wireless communication channel. The communications within the network 100 may conform to any suitable standard including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) or the sixth generation (6G) communication protocols.

As mentioned above, different carriers or cells are assumed co-located for FR1 intra-band CA and a MRTD of 3 us is expected considering similar propagation delays. Table 2 shows example subcarrier spacings (SCSs) supported by NR.

TABLE 2

| | Useful Symbol | Cyclic Prefix |
|---|---|---|
| SCS(kHz) | Time, Tᵤ(μs) | (CP), T_{CP}(μs) |
| 15 | 66.7 | 4.7 |
| 30 | 33.3 | 2.3 |
| 60 | 16.7 | 1.2 |
| 120 | 8.33 | 0.59 |
| 240 | 4.17 | 0.29 |

It can be seen from Table 2 that, with 15 kHz SCS, this MRTD of 3 μs ensures RTD at a terminal device within a CP length (e.g., 4.7 μs) so that data on multiple carriers may be processed or decoded without any interference. When SCS is 30 kHz or 60 kHz, the RTD may exceed the CP length, which shows potential performance degradation. Single receive chain has been assumed for intra-band carriers, and thus a terminal device is expected to receive the data from multiple carriers on one band using the single timing, which is named as a receive timing on an intra-band in the following context.

When a non-co-located scenario is introduced, if the MRTD shall follow the value defined for inter-band CA where non-co-located carriers are assumed, a longer MRTD (e.g., 33 μs) will be used for non-co-located intra-band CA scenario in FR1. Comparing with 3 μs which impacts only a small portion of a symbol, such MRTD of 33 μs may expand the potential performance degradation to up to 3 symbols based on the SCS. This will bring significant negative impact to system throughput. Here, MRTD of 33 μs is used as an example assuming 9 km propagation delay. In practice, the distance may be smaller than 9 km for non-co-located intra-band CA, and then MRTD could be adjusted between 3 μs and 33 μs accordingly.

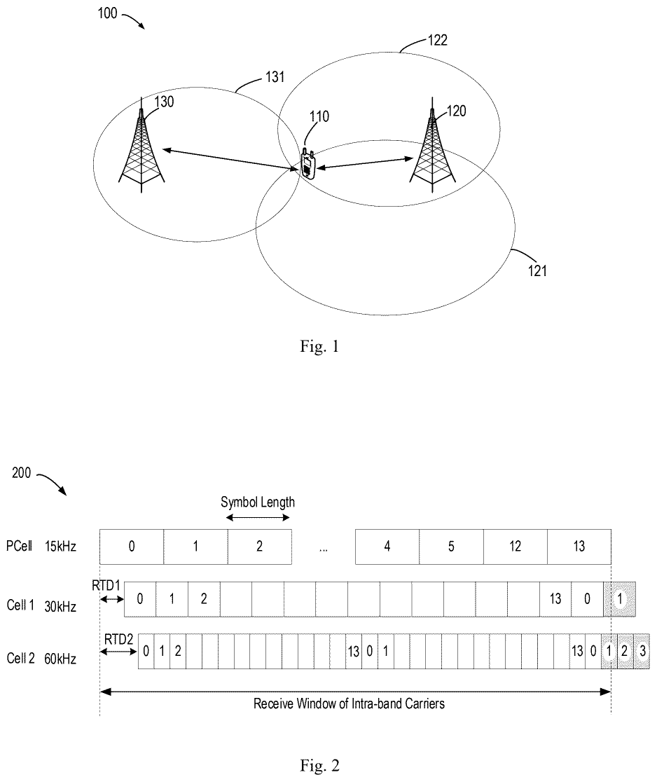

FIG. 2 illustrates a diagram 200 illustrating an example RTD between intra-band carriers in a non-co-located scenario in which embodiments of the present disclosure may be implemented. In this example, a terminal device is configured with non-co-located intra-band CA where the three carriers are operating on 15 kHz, 30 kHz and 60 kHz respectively. The carrier operating on 15 kHz corresponds to PCell, and the carriers operating on 30 kHz and 60 kHz correspond to Cell 1 and Cell 2 respectively.

As shown in FIG. 2, there is a time difference RTD1 on arrival timings between PCell and Cell 1 and there is a time difference RTD2 on arrival timings between PCell and Cell 2. In the worse case, if a RTD is 33 μs, and a terminal device operates the intra-band CA following the timing on PCell with 15 kHz SCS, data received from Cell 2 with 60 kHz SCS will be processed or decoded with more than 2 symbols shifts from the timing of Cell 2. As the terminal device has been required to handle only within 3 μs RTD according to existing requirement, data transmission on Cell 1 or 2 may not be properly received by the terminal device as it is shifted beyond UE requirement. The larger RTD is the terminal device experiencing, the more performance degradation is caused.

In addition, it may be observed that the performance degradation depends on the SCS applied in the Cell 1 or 2. With 30 kHz SCS on Cell 1, symbol #1 will be interrupted as RTD1 shifts almost the full symbol #1 out of a receive window of the intra-band carriers. With 60 kHz SCS on Cell 2, RTD2 moves symbol #2, 3 out of the receive window and also impacts on symbol #1. The performance degradation on Cell 2 with 60 kHz SCS is more severe than that on Cell 1 with 30 kHz SCS.

Considering the potential performance degradation, a network may need to avoid scheduling the terminal device on the interrupted symbols to ensure data transmission performance. However, the network is not always able to know the actually experienced RTD on the terminal device side, or the receive timing applied on the intra-band carriers. Especially in a non-co-located scenario, the network has no means to predict on which symbols and how many symbols the performance degradation would occur. It will be very challenging to determine if and where to schedule the terminal device with decent system performance.

It should also be mentioned that different UE architectures are expected to perform differently in terms of experienced performance degradation even under same RTD conditions. Thus, some UE implementations will be more robust against RTD and may compensate the performance degradation to some extent. However, some UE implementation may experience untolerable performance degradation and the scheduling shall not have been allowed.

In any case, the non-co-located scenario for FR1 intra-band CA leads to a longer RTD at a terminal device side, which may cause performance degradation on potentially a number of symbols. This brings challenges to network scheduling and system performance.

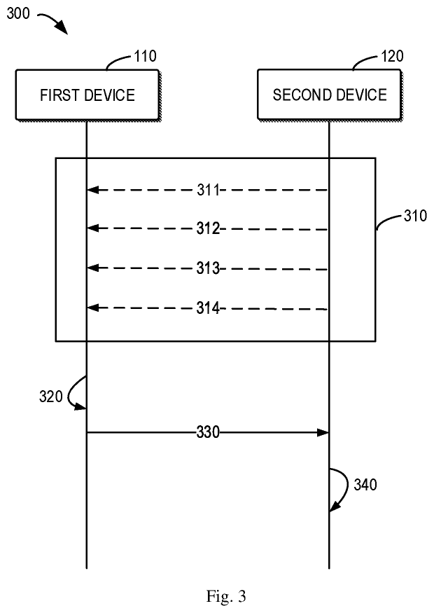

Thus, embodiments of the present disclosure provide a solution for handling a RTD of intra-band carriers. More details will be described below in connection with FIG. 3.

It is to be noted that the present solution may apply to intra-band CA scenario, and may also apply to intra-band EN-DC provided a terminal device does not indicate that it is capable of asynchronous frequency division duplex (FDD)-FDD EN-DC operation. In the context of the present disclosure, a RTD may refer to a time difference between a receive timing on intra-band and a receive timing of a carrier on the band. The term “band” may be interchangeably used with “frequency band”.

FIG. 3 illustrates a flowchart illustrating a diagram illustrating a process 300 of communication for RTD handling according to some embodiments of the present disclosure. For the purpose of discussion, the process 300 will be described with reference to FIG. 1. The process 300 may involve the first device 110 and the second device 120 as illustrated in FIG. 1. It is assumed that the first device 110 is served by the second device 120.

As shown in FIG. 3, the second device 120 transmits 310, to the first device 110, an indication indicating that information of a RTD between a non-co-located cell (for convenience, also referred to as a first cell herein, e.g., the cell 131) and a serving cell, or a RTD between a non-co-located cell and the receive timing of an intra-band is to be reported. In some embodiments, the serving cell may be a PCell. In some embodiments, the serving cell may be a SCell co-located with the PCell. It is to be understood that a receive timing of the serving cell serves as a receive timing of an intra-band.

In some embodiments, the information of the RTD may comprise a reference timing for the RTD (i.e., the receive timing of the intra-band). In other words, the first device 110 may be indicated to report which cell timing is used as a receive timing on an intra-band.

In some embodiments, the first device 110 may determine a receive timing of a PCell (e.g., the cell 121) as the reference timing. In some embodiments, the first device 110 may determine a receive timing of a primary secondary cell (PSCell) as the reference timing. In some embodiments, the first device 110 may determine a receive timing of a SCell (e.g., the cell 122) as the reference timing, the SCell being one of a set of SCells that are co-located with the PCell or PSCell in a frequency band. In some embodiments, the first device 110 may use a default or predetermined receive timing (e.g., PCell) as the reference timing.

In some embodiments, the information of the RTD may comprise information (for convenience, also referred to first information herein) indicating whether the RTD between a timing of the first cell and the reference timing fulfils a predetermined requirement. In other words, the first device 110 may be indicated to report whether the RTD fulfils the predetermined requirement.

In some embodiments, if the RTD is lower than a threshold, the first device 110 may determine that the RTD fulfils the predetermined requirement. If the RTD is higher than the threshold, the first device 110 may determine that the RTD does not fulfil the predetermined requirement. In some embodiments, if the RTD is equal to the threshold, the first device 110 may determine that the RTD does not fulfil the predetermined requirement. In some embodiments, if the RTD is equal to the threshold, the first device 110 may determine that the RTD fulfils the predetermined requirement.

In some embodiments, the information of the RTD may comprise information (for convenience, also referred to second information herein) of a set of symbols that are to experience performance degradation on the first cell. In other words, the first device 110 may be indicated to report information of the set of symbols.

In some embodiments, the first device 110 may determine, as the information of the set of symbols, the number of symbols in the set of symbols. In some embodiments, the first device 110 may determine, as the information of the set of symbols, an index of a symbol (e.g., each symbol) in the set of symbols. For example, if the cell 121 is the PCell in FIG. 2 and the cell 131 is the Cell 1 in FIG. 2, the set of symbols may comprise symbol #1 of Cell 1. If the cell 121 is the PCell in FIG. 2 and the cell 131 is the Cell 2 in FIG. 2, the set of symbols may comprise symbol #1, 2, 3 of Cell 2.

In some embodiments, the information of the RTD may comprise information (for convenience, also referred to third information herein) indicating a level of performance degradation. In other words, the first device 110 may be indicated to report the level of performance degradation. For example, the first device 110 may indicate how severe the performance degradation is foreseen and whether scheduling restriction is expected on the first cell.

For example, if the receive timing of the first cell is shifted by only several s (e.g., the symbol #1 of Cell 1 in FIG. 2), the performance degradation is not severe and the first device 110 may just indicate a slight performance degradation which may not stop the second device 120 from scheduling the first device 110. As another example, if the receive timing of the first cell is shifted a lot as exampled in symbol #2,3 of Cell 2 in FIG. 2, the performance degradation cannot be compensated by the first device 110. In this case, the first device 110 may indicate a severe performance degradation which may stop the second device 120 from scheduling the first device 110, e.g., on related symbols or stop the first device 110 from reacting to the scheduling on related symbols. With different levels of performance degradation, the second device 120 may be able to behave differently when scheduling the first device 110.

In some embodiments, the information of the RTD may comprise information (for convenience, also referred to fourth information herein) indicating a level of the RTD. In other words, the first device 110 may be indicated to report the level of the RTD.

In some embodiments, the level of the RTD may be associated with a CP (e.g., CP length). For example, the RTD may be lower than or equal to a CP length. As another example, the RTD may be between a CP length and twice of a CP length. As still another example, the RTD may be larger than twice of a CP length. It is to be understood that these example are merely for illustration, and any other suitable ways are also feasible.

It is to be understood that the second device 120 may indicate the first device 110 to report any combination of the above information of the RTD and any other suitable information of the RTD.

Continue to refer to FIG. 3, in some embodiments, the second device 120 may transmit 311, to the first device 110, an indication indicating whether the first cell is co-located or non-co-located with a serving cell in a frequency band. If the indication indicates that the first cell is non-co-located with the serving cell, the first device 110 may determine that the information of the RTD relevant to the first cell and the serving cell is to be reported, and may evaluate 320 the RTD. If the indication indicates that the first cell is co-located with the serving cell, the first device 110 may not evaluate the RTD.

In some embodiments, the second device 120 may transmit 312, to the first device 110, a configuration for inter-frequency measurements on the first cell. Upon reception of the configuration, the first device 110 may determine that the information of the RTD relevant to the first cell and the serving cell is to be reported, and may evaluate 320 the RTD.

In some embodiments, the second device 120 may transmit 313, to the first device 110, a configuration indicating that the first cell is to be configured as a SCell. Upon reception of the configuration, the first device 110 may determine that the information of the RTD relevant to the first cell and the serving cell is to be reported, and may evaluate 320 the RTD.

In some embodiments where the first cell has been configured as a SCell, the second device 120 may transmit 314, to the first device 110, a configuration indicating that the first cell is to be activated based on the evaluation of RTD.

In some embodiments for RTD evaluation, the first device 110 may evaluate the RTD based on measurements or monitoring of downlink reference signals from the serving cell and the first cell. It is to be understood that the RTD evaluation may be performed in any suitable ways and the present disclosure does not limit this aspect. As a result, the information of the RTD may be obtained.

With reference to FIG. 3, the first device 110 may transmit 330 the information of the RTD to the second device 120. In some embodiments, the first device 110 may transmit, to the second device 120, a measurement report comprising the information of the RTD. It is to be understood that any other suitable ways are also feasible.

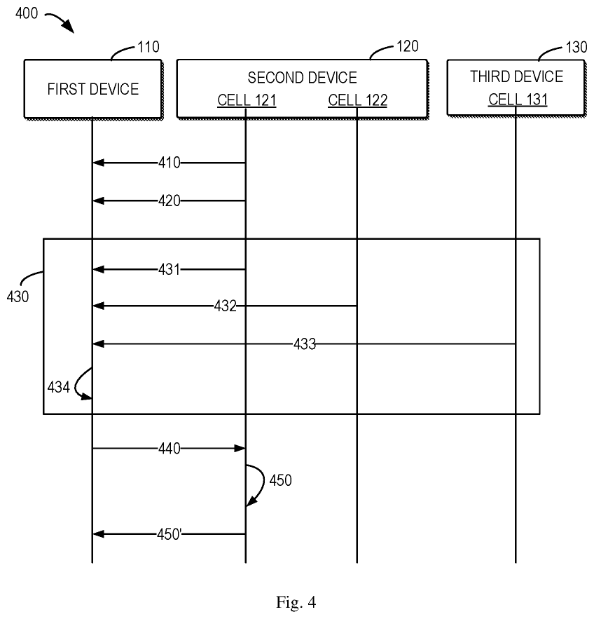

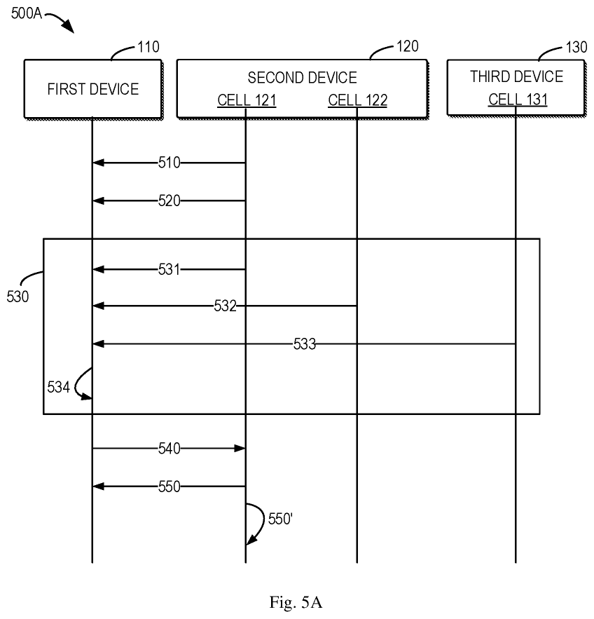

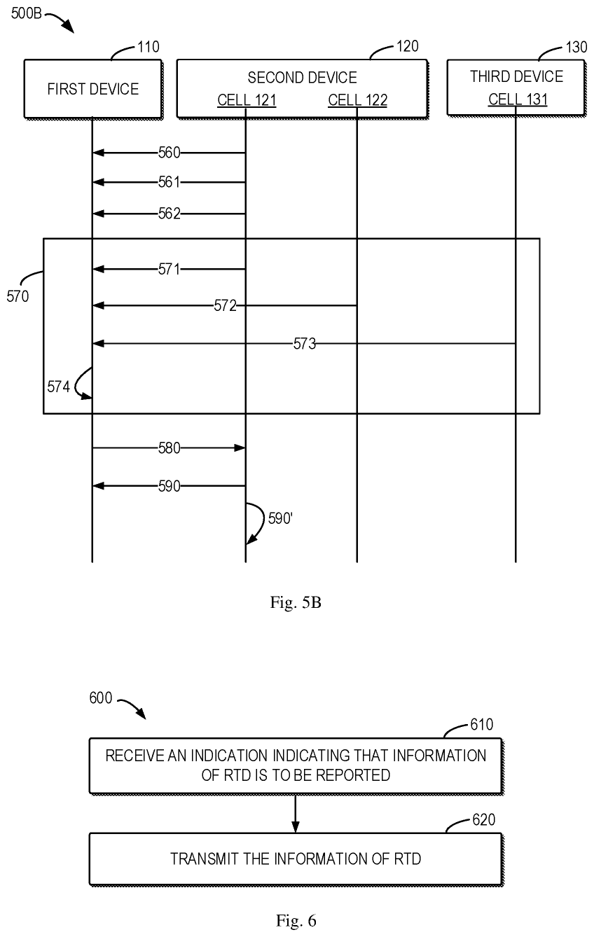

Based on the information of the RTD, the second device 120 may manage 340 a scheduling of the first device 110. For illustration, some example embodiments will be described in connection with FIGS. 4 to 5B.

FIG. 4 illustrates a diagram illustrating an example process 400 of adding a cell as a SCell according to some embodiments of the present disclosure. For the purpose of discussion, the process 400 will be described with reference to FIG. 1. The process 400 may involve the first device 110, the second device 120 and the third device 130 as illustrated in FIG. 1. It is assumed that the first device 110 is served by the second device 120 via the cells 121 and 122. The cell 121 serves as a PCell, and the cell 122 serves as a SCell. The cell 121 is co-located with the cell 122. The cell 131 (i.e., the first cell) is not connected with the first device 110 and is non-co-located with the cells 121 and 122. The cells 121, 122 and 131 are on the same frequency band.

As shown in FIG. 4, the second device 120 (via PCell) may transmit 410, to the first device 110, an indication indicating that the cell 131 is non-co-located. The second device 120 may also transmit 420, to the first device 110, a configuration for inter-frequency measurements on the cell 131. Based on the configuration for inter-frequency measurements, the first device 110 may detect and measure the cell 131.

Then the first device 110 may evaluate 430 a RTD of the cell 131. With reference to FIG. 4, the first device 110 may measure 431 downlink reference signals from the cell 121. The first device 110 may measure 432 downlink reference signals from the cell 122. The first device 110 may measure 433 downlink reference signals from the cell 131. Then the first device 110 may determine 434 information of the RTD of the cell 131 based on measurements of downlink reference signals from the cells 121, 122 and 131.

As shown in FIG. 4, the first device 110 may transmit 440 the information of the RTD to the second device 120 (via PCell or the SCell configured with physical uplink control channel (PUCCH)). Other details about the information of the RTD are similar to that described in connection with FIG. 3 and thus are not repeated here for conciseness.

If the information of the RTD indicates that severe performance degradation may be caused, the second device 120 may not configure 450 the first cell 131 as a SCell. If the information of the RTD indicates that no or slight performance degradation may be caused, the second device 120 may transmit 450′ a configuration (also referred to a SCell configuration herein) indicating that the first cell is added as a SCell.

For example, if the RTD is lower than or equal to the threshold, the second device 120 may transmit the SCell configuration. In another example, if a slight performance degradation is indicated, the second device 120 may transmit the SCell configuration. In still another example, if the RTD is lower than or equal to the CP length, the second device 120 may transmit the SCell configuration. It is to be understood that the above conditions may be used in any suitable combination for determination of the transmission of the SCell configuration.

FIG. 5A illustrates a diagram illustrating an example process 500A of activating a cell configured as a SCell according to some embodiments of the present disclosure. For the purpose of discussion, the process 500A will be described with reference to FIG. 1. The process 500A may involve the first device 110, the second device 120 and the third device 130 as illustrated in FIG. 1. It is assumed that the first device 110 is served by the second device 120 via the cells 121 and 122. The cell 121 serves as a PCell, and the cell 122 serves as a SCell. The cell 121 is co-located with the cell 122. The cell 131 (i.e., the first cell) is configured as a SCell and is non-co-located with the cells 121 and 122. The cells 121, 122 and 131 are on the same frequency band.

As shown in FIG. 5A, the second device 120 (via PCell) may transmit 510, to the first device 110, an indication indicating that the cell 131 is non-co-located. The second device 120 may transmit 520, to the first device 110, a SCell configuration indicating that the cell 131 is to be configured as a SCell.

Based on reception of the SCell configuration, the first device 110 may evaluate 530 a RTD of the cell 131. With reference to FIG. 5A, the first device 110 may measure 531 downlink reference signals from the cell 121. The first device 110 may measure 532 downlink reference signals from the cell 122. The first device 110 may measure 533 downlink reference signals from the cell 131. Then the first device 110 may determine 534 information of the RTD of the cell 131 based on measurements of downlink reference signals from the cells 121, 122 and 131.

As shown in FIG. 5A, the first device 110 may transmit 540 the information of the RTD to the second device 120 (via PCell or the SCell configured with PUCCH). Other details about the information of the RTD are similar to that described in connection with FIG. 3 and thus are not repeated here for conciseness.

If the information of the RTD indicates that no or slight performance degradation may be caused, the second device 120 may transmit 550 a command to activate the first cell. For example, the second device 120 may transmit a medium access control (MAC) control element (CE) (e.g., SCell activation command) to activate the cell 131. It is to be noted that the command may adopt any other suitable forms. If the information of the RTD indicates that severe performance degradation may be caused, the second device 120 may not activate 550′ the first cell.

FIG. 5B illustrates a diagram illustrating an example process 500B of deactivating a cell configured as a SCell according to some embodiments of the present disclosure. For the purpose of discussion, the process 500B will be described with reference to FIG. 1. The process 500B may involve the first device 110, the second device 120 and the third device 130 as illustrated in FIG. 1. It is assumed that the first device 110 is served by the second device 120 via the cells 121 and 122. The cell 121 serves as a PCell, and the cell 122 serves as a SCell. The cell 121 is co-located with the cell 122. The cell 131 (i.e., the first cell) is configured as a SCell and is non-co-located with the cells 121 and 122. The cells 121, 122 and 131 are on the same frequency band.

As shown in FIG. 5B, the second device 120 (via PCell) may transmit 560, to the first device 110, an indication indicating that the cell 131 is non-co-located. The second device 120 may transmit 561, to the first device 110, a SCell configuration indicating that the cell 131 is to be configured as a SCell.

Continue to refer to FIG. 5B, the second device 120 may transmit 562, to the first device 110, a command indicating that the cell 131 is activated. For example, the second device 120 may transmit a MAC CE activating the cell 131. It is to be noted that the command may adopt any other suitable forms.

Based on reception of the command, the first device 110 may evaluate 570 a RTD of the cell 131. With reference to FIG. 5B, the first device 110 may measure 571 downlink reference signals from the cell 121. The first device 110 may measure 572 downlink reference signals from the cell 122. The first device 110 may measure 573 downlink reference signals from the cell 131. Then the first device 110 may determine 574 information of the RTD of the cell 131 based on measurements of downlink reference signals from the cells 121, 122 and 131.

As shown in FIG. 5B, the first device 110 may transmit 580 the information of the RTD to the second device 120 (via PCell). Other details about the information of the RTD are similar to that described in connection with FIG. 3 and thus are not repeated here for conciseness.

If the information of the RTD shows that severe performance degradation may be caused, the second device 120 may transmit 590 a command to deactivate the first cell. For example, the second device 120 may transmit a MAC CE deactivating the cell 131. It is to be noted that the command may adopt any other suitable forms. If the information of the RTD shows that no or slight performance degradation may be caused, the second device 120 may not deactivate 590′ the first cell. Other details of the processes of FIGS. 4, 5A and 5B are similar to that described in FIG. 3, and thus are omitted for conciseness.

With the processes described above, RTD information of non-co-located intra-band carriers may be indicated to a network and network scheduling and system performance may be improved. It is to be noted that the above processes as shown in FIGS. 3 to 5B are merely examples, and may have additional or less operations. It is also to be noted that the above processes as shown in FIGS. 4 to 5B may be carried out separately or in any suitable combination.

Corresponding to the above processes, example embodiments of the present disclosure also provide methods of communication. FIG. 6 illustrates a flowchart of an example method 600 implemented at a first device according to some embodiments of the present disclosure. For the purpose of discussion, the method 600 will be described with reference to FIG. 1.

At block 610, the first device 110 receives, from the second device 120, an indication indicating that information of a RTD relevant to a first cell and a serving cell is to be reported, the first cell being non-co-located with the serving cell in a frequency band. In some embodiments, the serving cell is one of a PCell and a set of SCells that are co-located in the frequency band.

In some embodiments, the first device 110 may receive, from the second device 120, an indication indicating that the first cell is non-co-located with the serving cell in the frequency band. In this way, the first device 110 may start evaluating the RTD.

At block 620, the first device 110 transmits, to the second device 120, the information of the RTD.

In some embodiments, the information of the RTD comprises at least one of the following: a reference timing for the RTD, first information indicating whether the RTD between a timing of the first cell and the reference timing fulfils a predetermined requirement, second information of a set of symbols that are to experience performance degradation on the first cell, third information indicating a level of performance degradation, or fourth information indicating a level of the RTD.

In some embodiments, the reference timing is one of the following: a receive timing of a PCell or PSCell, a receive timing of a SCell in a set of SCells that are co-located with the PCell or PSCell in the frequency band, or a predetermined receive timing. In some embodiments, the second information comprises at least one of the following: the number of symbols in the set of symbols, or an index of a symbol in the set of symbols. In some embodiments, the level of the receive timing difference is associated with a cyclic prefix.

In some embodiments, the first device 110 may receive, from the second device 120, a configuration for inter-frequency measurements on the first cell. Based on reception of the configuration, the first device 110 may evaluate and transmit the information of the RTD. In some embodiments, the first device 110 may receive, from the second device 120, a configuration indicating that the first cell is added as a secondary cell based on the information of the RTD. In some embodiments, if the information of the receive timing difference indicates that no or slight performance degradation is caused, the first device 110 may receive, from the second device 120, the configuration indicating that the first cell is added as a secondary cell.

In some embodiments, the first device 110 may receive, from the second device 120, a configuration indicating that the first cell is to be configured as a SCell. Based on reception of the configuration, the first device 110 may evaluate and transmit the information of the RTD. In some embodiments, the first device 110 may receive, from the second device 120, a command indicating that the first cell configured as a SCell is to be activated based on the information of the RTD. In some embodiments, if the information of the receive timing difference indicates that no or slight performance degradation is caused, the first device 110 may receive, from the second device 120, the command indicating that the first cell configured as a SCell is to be activated.

In some embodiments, the first device 110 may receive, from the second device 120, a configuration indicating that the first cell configured as a SCell is activated. Based on reception of the configuration, the first device 110 may evaluate and transmit the information of the RTD. In some embodiments, the first device 110 may receive, from the second device 120, a command indicating that the first cell configured as a SCell is to be deactivated based on the information of the RTD. In some embodiments, if the information of the receive timing difference indicates that no or slight performance degradation is caused, the first device 110 may receive, from the second device 120, a command indicating that the first cell configured as a SCell is to be deactivated.

With the method 600, a terminal device may indicate information of RTD of a non-co-located cell to a network.

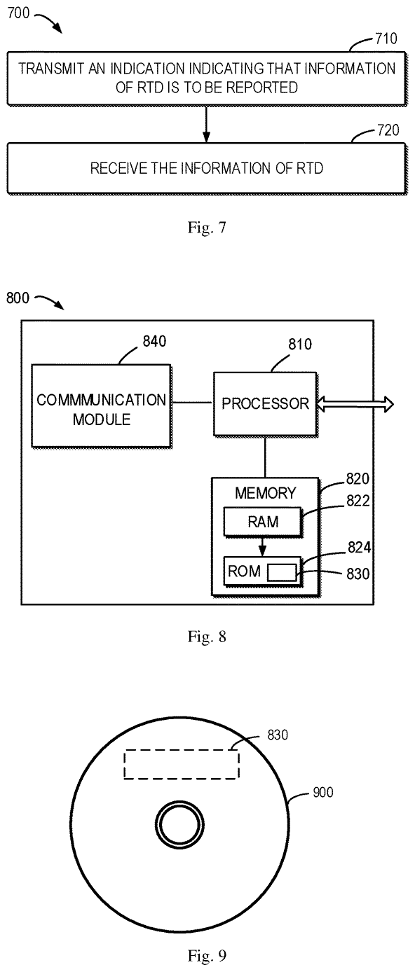

FIG. 7 illustrates a flowchart of an example method 700 implemented at a second device according to some embodiments of the present disclosure. For the purpose of discussion, the method 700 will be described with reference to FIG. 1.

At block 710, the second device 120 transmits, to the first device 110, an indication indicating that information of a RTD relevant to a first cell and a serving cell is to be reported, the first cell being non-co-located with the serving cell in a frequency band. In some embodiments, the serving cell is one of a PCell and a set of SCells that are co-located in the frequency band.

In some embodiments, the second device 120 may transmit, to the first device 110, an indication indicating that the first cell is non-co-located with the serving cell in the frequency band.

At block 720, the second device 120 receives, from the first device 110, information of the RTD.

In some embodiments, the information of the RTD comprises at least one of the following: a reference timing for the RTD, first information indicating whether the RTD between a timing of the first cell and the reference timing fulfils a predetermined requirement, second information of a set of symbols that are to experience performance degradation on the first cell, third information indicating a level of performance degradation, or fourth information indicating a level of the RTD.

In some embodiments, the reference timing is one of the following: a receive timing of a PCell or a PSCell, a receive timing of a SCell in a set of SCells that are co-located with the PCell or PSCell in the frequency band, or a predetermined receive timing. In some embodiments, the second information comprises at least one of the following: the number of symbols in the set of symbols, or an index of a symbol in the set of symbols. In some embodiments, the level of the receive timing difference is associated with a cyclic prefix.

In some embodiments, the second device 120 may transmit, to the first device 110, a configuration for inter-frequency measurements on the first cell. Based on the received information of the RTD, the second device 120 may manage a scheduling for the first device 110. In some embodiments, the second device 120 may transmit, to the first device 110, a configuration indicating that the first cell is added as a secondary cell based on the information of the RTD. In some embodiments, if the information of the receive timing difference indicates that no or slight performance degradation is caused, the second device 120 may transmit, to the first device 110, the configuration indicating that the first cell is added as a secondary cell.

In some embodiments, the second device 120 may transmit, to the first device 110, a configuration indicating that the first cell is to be configured as a SCell. Based on the received information of the RTD, the second device 120 may manage a scheduling for the first device 110. In some embodiments, the second device 120 may transmit, to the first device 110, a command indicating that the first cell configured as a SCell is to be activated based on the information of the RTD. In some embodiments, if the information of the receive timing difference indicates that no or slight performance degradation is caused, the second device 120 may transmit, to the first device 110, the command indicating that the first cell configured as a SCell is to be activated.

In some embodiments, the second device 120 may transmit, to the first device 110, a configuration indicating that the first cell configured as a SCell is activated. Based on the received information of the RTD, the second device 120 may manage a scheduling for the first device 110. In some embodiments, the second device 120 may transmit, to the first device 110, a command indicating that the first cell configured as a SCell is to be deactivated based on the information of the RTD. In some embodiments, if the information of the receive timing difference indicates that no or slight performance degradation is caused, the second device 120 may transmit, to the first device 110, the command indicating that the first cell configured as a SCell is to be deactivated.

With the method 700, a network device may manage a scheduling for a terminal device based on received information of RTD of a non-co-located cell.

It is to be noted that the operations of the methods 600 to 700 correspond to that described in connection with FIGS. 3 to 5B, and thus other details are not repeated here for conciseness.

Example embodiments of the present disclosure also provide the corresponding apparatus. In some embodiments, an apparatus (for example, the first device 110) capable of performing the method 600 may comprise means for performing the respective steps of the method 600. The means may be implemented in any suitable form. For example, the means may be implemented in a circuitry or software module.

In some embodiments, the apparatus comprises: means for receiving, at a first device and from a second device, an indication indicating that information of a receive timing difference relevant to a first cell and a serving cell is to be reported, the first cell being non-co-located with the serving cell in a frequency band; and means for transmitting, to the second device, the information of the receive timing difference.

In some embodiments, the apparatus may further comprise: means for receiving, from the second device, an indication indicating that the first cell is non-co-located with the serving cell in the frequency band.

In some embodiments, the information of the receive timing difference comprises at least one of the following: a reference timing for the receive timing difference, first information indicating whether the receive timing difference between a timing of the first cell and the reference timing fulfils a predetermined requirement, second information of a set of symbols that are to experience performance degradation on the first cell, third information indicating a level of performance degradation, or fourth information indicating a level of the receive timing difference.

In some embodiments, the reference timing is one of the following: a receive timing of a primary cell or a primary secondary cell, a receive timing of a secondary cell in a set of secondary cells that are co-located with the primary cell or the primary secondary cell in the frequency band, or a predetermined receive timing. In some embodiments, the second information comprises at least one of the following: the number of symbols in the set of symbols, or an index of a symbol in the set of symbols. In some embodiments, the level of the receive timing difference is associated with a cyclic prefix.

In some embodiments, the means for receiving the indication may comprise means for receiving, from the second device, a configuration for inter-frequency measurements on the first cell.

In some embodiments, the apparatus may further comprise: means for receiving, from the second device, a configuration indicating that the first cell is added as a secondary cell based on the information of the receive timing difference.

In some embodiments, the means for receiving the indication may comprise means for receiving, from the second device, a configuration indicating that the first cell is to be configured as a secondary cell; or means for receiving, from the second device, a configuration indicating that the first cell configured as a secondary cell is activated.

In some embodiments, the apparatus may further comprise: means for receiving, from the second device, a command indicating that the first cell configured as a secondary cell is activated or deactivated based on the information of the receive timing difference.

In some embodiments, the serving cell is one of a primary cell, a primary secondary cell and a set of secondary cells that are co-located in the frequency band.

In some embodiments, an apparatus (for example, the second device 120) capable of performing the method 700 may comprise means for performing the respective steps of the method 700. The means may be implemented in any suitable form. For example, the means may be implemented in a circuitry or software module.

In some embodiments, the apparatus comprises: means for transmitting, to a first device, an indication indicating that information of a receive timing difference relevant to a first cell and a serving cell is to be reported, the first cell being non-co-located with the serving cell in a frequency band; and means for receiving, from the first device, the information of the receive timing difference.

In some embodiments, the apparatus may further comprise: means for transmitting, to the first device, an indication indicating that the first cell is non-co-located with the serving cell in the frequency band.

In some embodiments, the information of the receive timing difference comprises at least one of the following: a reference timing for the receive timing difference, first information indicating whether the receive timing difference between a timing of the first cell and the reference timing fulfils a predetermined requirement, second information of a set of symbols that are to experience performance degradation on the first cell, third information indicating a level of performance degradation, or fourth information indicating a level of the receive timing difference.

In some embodiments, the reference timing is one of the following: a receive timing of a primary cell or a primary secondary cell, a receive timing of a secondary cell in a set of secondary cells that are co-located with the primary cell or the primary secondary cell in the frequency band, or a predetermined receive timing. In some embodiments, the second information comprises at least one of the following: the number of symbols in the set of symbols, or an index of a symbol in the set of symbols. In some embodiments, the level of the receive timing difference is associated with a cyclic prefix.

In some embodiments, the means for transmitting the indication may comprise means for transmitting, to the first device, a configuration for inter-frequency measurements on the first cell.

In some embodiments, the apparatus may further comprise: means for transmitting, to the first device, a configuration indicating that the first cell is added as a secondary cell based on the information of the receive timing difference.

In some embodiments, the means for transmitting the indication may comprise: means for transmitting, to the first device, a configuration indicating that the first cell is to be configured as a secondary cell; or means for transmitting, to the first device, a configuration indicating that the first cell configured as a secondary cell is to be activated.

In some embodiments, the apparatus may further comprise: means for transmitting, to the first device, a command indicating that the first cell is activated or deactivated based on the information of the receive timing difference.

In some embodiments, the serving cell is one of a primary cell, a primary secondary cell and a set of secondary cells that are co-located in the frequency band.

FIG. 8 is a simplified block diagram of a device 800 that is suitable for implementing embodiments of the present disclosure. The device 800 may be provided to implement the communication device, for example the first device 110, the second device 120 or the third device 130 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 820. The processor 810 may perform any suitable actions and processing by loading the program 830 into the RAM 820.

The embodiments of the present disclosure may be implemented by means of the program 830 so that the device 800 may perform any process of the disclosure as discussed with reference to FIGS. 1 to 7. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 or 700 as described above with reference to FIGS. 6 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-24. (canceled)

25. A first device comprising:
at least one processor; and
at least one memory storing instructions that, when executed by the at least one processor, cause the first device at least to:
receive, from a second device, an indication indicating that information of a receive timing difference relevant to a first cell and a serving cell is to be reported, the first cell being non-co-located with the serving cell in a frequency band; and
transmit, to the second device, the information of the receive timing difference.

26. The first device of claim 25, wherein the first device is further caused to:
receive, from the second device, an indication indicating that the first cell is non-co-located with the serving cell in the frequency band.

27. The first device of claim 25, wherein the information of the receive timing difference comprises at least one of the following:
a reference timing for the receive timing difference,
first information indicating whether the receive timing difference between a timing of the first cell and the reference timing fulfils a predetermined requirement,
second information of a set of symbols that are to experience performance degradation on the first cell,
third information indicating a level of performance degradation, or
fourth information indicating a level of the receive timing difference.

28. The first device of claim 27, wherein the reference timing is one of the following:
a receive timing of a primary cell or a primary secondary cell,
a receive timing of a secondary cell in a set of secondary cells that are co-located with the primary cell or the primary secondary cell in the frequency band, or
a predetermined receive timing.

29. The first device of claim 27, wherein the second information comprises at least one of the following:
the number of symbols in the set of symbols, or
an index of a symbol in the set of symbols.

30. The first device of claim 27, wherein the level of the receive timing difference is associated with a cyclic prefix.

31. The first device of claim 25, wherein the first device is caused to receive the indication by:
receiving, from the second device, a configuration for inter-frequency measurements on the first cell.

32. The first device of claim 25, wherein the first device is further caused to:
receive, from the second device, a configuration indicating that the first cell is added as a secondary cell based on the information of the receive timing difference.

33. The first device of claim 25, wherein the first device is caused to receive the indication by:
receiving, from the second device, a configuration indicating that the first cell is to be configured as a secondary cell; or
receiving, from the second device, a configuration indicating that the first cell configured as a secondary cell is activated.

34. The first device of claim 25, wherein the first device is further caused to:
receive, from the second device, a command indicating that the first cell configured as a secondary cell is activated or deactivated based on the information of the receive timing difference.

35. The first device of claim 25, wherein the serving cell is one of a primary cell, a primary secondary cell and a set of secondary cells that are co-located in the frequency band.

36. A second device comprising:
at least one processor; and
at least one memory storing instructions that, when executed by the at least one processor, cause the second device at least to:
transmit, to a first device, an indication indicating that information of a receive timing difference relevant to a first cell and a serving cell is to be reported, the first cell being non-co-located with the serving cell in a frequency band; and
receive, from the first device, the information of the receive timing difference.

37. A method of communication comprising:
receiving, at a first device and from a second device, an indication indicating that information of a receive timing difference relevant to a first cell and a serving cell is to be reported, the first cell being non-co-located with the serving cell in a frequency band; and
transmitting, to the second device, the information of the receive timing difference.

38. The method of claim 37, further comprising:
receiving, from the second device, an indication indicating that the first cell is non-co-located with the serving cell in the frequency band.

39. The method of claim 37, wherein the information of the receive timing difference comprises at least one of the following:
a reference timing for the receive timing difference,
first information indicating whether the receive timing difference between a timing of the first cell and the reference timing fulfils a predetermined requirement,
second information of a set of symbols that are to experience performance degradation on the first cell,
third information indicating a level of performance degradation, or
fourth information indicating a level of the receive timing difference.

40. The method of claim 39, wherein the reference timing is one of the following:
a receive timing of a primary cell or a primary secondary cell,
a receive timing of a secondary cell in a set of secondary cells that are co-located with the primary cell or the primary secondary cell in the frequency band, or
a predetermined receive timing.

41. The method of claim 39, wherein the second information comprises at least one of the following:
the number of symbols in the set of symbols, or
an index of a symbol in the set of symbols.

42. The method of claim 39, wherein the level of the receive timing difference is associated with a cyclic prefix.

43. The method of claim 37, further comprising receiving the indication by:
receiving, from the second device, a configuration for inter-frequency measurements on the first cell.

44. The method of claim 37, further comprising:
receiving, from the second device, a configuration indicating that the first cell is added as a secondary cell based on the information of the receive timing difference.
